(19) United States
(12) Patent Application Publication
(10) Pub. No.: US 2008/0083375 A1
(43) Pub. Date: Apr. 10, 2008

(54) Bird feeder with squirrel protection

(76) Inventor: Aram A. Stepanian, Sutton, MA (US)

Correspondence Address: ARAM A STEPANIAN, 17 JUDITH CIRCLE, SUTTON, MA, 01590, US

(21) Appl. No.: 11/526,334

(22) Filed: Sep. 25, 2006

(51) Int. Cl. A01K 61/02

(52) U.S. Cl. 119/52.3

(57) ABSTRACT

A bird feeder having a gated feed access opening, and a squirrel or other undesired animal detector and repulsion devices is presented. The structure may have a rotating perch or landing area to throw off animals having a greater weight than an adjustable set point in addition to shutting the feed access gate. The structure may also have smooth sidewalls to prevent non flying animals from gaining access to the feed access openings.

### TECHNICAL FIELD

This disclosure relates generally to methods and structures for wild animal feeding, and more specifically to preventing squirrels from accessing bird feeders.

### BACKGROUND

Certain persistent animals, such as squirrels, empty bird feeders rapidly, resulting in lost feeding opportunities for desirable bird. Fewer feeding resources may result in fewer birds remaining in the general area of the feeder, and thus loss of desirable visual and auditory experiences, and potential increase in local insect population, which may lead to health concerns.

There have been many attempts to prevent animals such as squirrels from gaining access to the bird feeders, including the use of overhanging roofs, slippery sides, closing doors or gates, and rotating devices. However, squirrels can jump great distances, and do not need to be able to hold on to any portion of the feeder, since the disruption of the stable position of the feeder may typically result in a portion of the feed spilling out onto the ground, where the squirrels may feed at their leisure.

A potential issue with the use of a rotating feeder is that the rapid rotation needed to cast the undesired animal off of the feeder may typically be sufficient to partially empty the feeder due to centrifugal force acting upon the feed. Thus, the potential solutions to undesired animal access to bird feeders may reduce the amount of lost feed, but a great deal of feed is still lost and wasted.

What is need in response to the above noted problems, is a method that prevents a squirrel or other undesired animal from remaining in the vicinity of the feeder, and reduces the amount of feed spilled during repeated attempts to access the feed container.

### BRIEF DESCRIPTION OF THE DRAWINGS

FIG. 1 illustrates a feeder device according to various embodiments of the invention; and

FIG. 2 illustrates a feeder device, according to various alternative embodiments of the invention.

### DETAILED DESCRIPTION

When an undesired animal attempts to access a feeder station intended to for certain birds, a device to reduce or prevent the loss of bird or other animal feed includes, a support structure connected to a food container, with a number of feed openings providing access to the interior of the food container. The interior may have a number of independent food containers, with each one connected to a different feed opening. There may be a circular landing area or perch located outside the food container next to one or more of the feed openings. There may be a number of different perches, perhaps with one located next to each of the openings, but a circular perch may provide a place for birds waiting for a vacant feed opening. In either event, the landing area or perch is capable of rotating relative to the feed openings. The perch may rotate around a long symmetrical axis of the bird feeder, and may rotate at about sixty revolutions per minute in response to an undesired animal's presence. There may be a switch connected to the perch, which responds either to a selected weight on the perch, or a variation in the slope of the feeder away from vertical with may indicate an animal or high wind, or to movement of the perch. The activation of the switch causes a movable gate or door to close the feeder opening by activation of a motor, relay or solenoid, and activates a motor connected to the circular perch to rotate the landing area or perch away from the feeder openings and to cause the animal to leave the landing area.

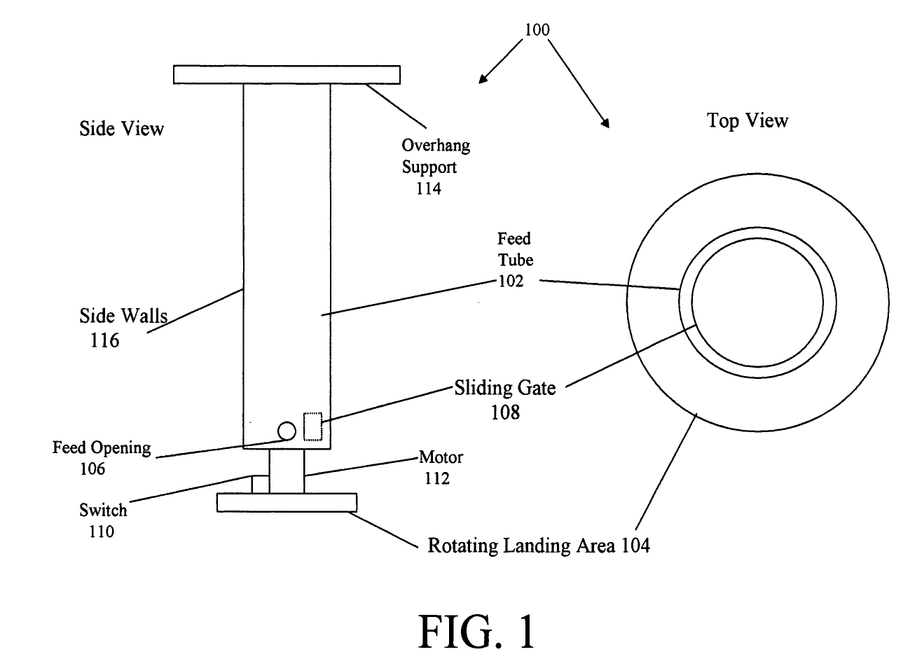

FIG. 1 illustrates a feeder device 100 according to various embodiments of the invention, from both a side view and a top view. The feeder 100 has a feed container tube 102, a landing area 104 that is set at a height appropriate for the size of the desired type of bird or other animal. The landing area 104, or perch may typically have a number of spokes connecting the landing area 104 to a central symmetry axis of the feed tube 102, to enable rotation of the landing area 104 with respect to the feed tube 102. In other embodiments, both the landing area 104 and the feed tube 102 rotate both with respect to each other, and to a support structure.

The feed tube 102 contains a number of feed openings 106, which may have various opening sizes to encourage certain types of birds and discourage the presence of other types of birds. The feed openings 106 each have a movable gate 108 positioned to close the opening 106 at selected times. The movable gates may slide in a ring on the inside of the feed tube 102 as shown, or may be positioned on the outside of the tube 102 to avoid potential jamming of the slide mechanism by especially small bird feed types, such a thistle seed. The movable gates may alternatively swing shut from the outside on hinges, drop from the top to cover the feed opening, of be raised from the bottom, among other easily understood methods to close an opening, including an iris type shutter.

The landing area 104 may include a switch 110 that responds to a weight on the landing area 104. The switch may respond to a radio signal, a clock or timer, a moisture sensor, to variations in the angle of the landing area 104 from horizontal, or to motion of the landing area, in addition to a weight limit. The switch 110 may typically be located at the attachment point between the landing area 104 and a shaft of a motor 112. The actuation of the switch 110 initiates the rotation of motor 112 causing the landing area to rotate with relation to the feed opening 106, and dislodging the undesired animal from the landing area. The weight limit for operation of the switch 110 may be made low enough to prevent larger birds from using the feeder 100 as well as preventing squirrels from remaining in the vicinity of the feed opening 106. The rotation of the landing area 104 and the rocking of the feed tube 102 may allow some of the feed to be expelled from the feed opening 106. This loss of feed is reduced by the operation of sliding gates 108 to close the feed opening 106 in response to activation of the switch 110. The gate 108 may be operated by the rotation of the landing area under the drive of the motor 112, or it may be independently operated by a solenoid, relay or a separate motor.

The feeder 100 may typically be hung from a pole or other support from a top portion of the feeder by a support 114, which may also be an overhang to render more difficult a non flying animal's access to the landing area 104. In addition, the vertical side walls 116 of the feed tube 102 may be smooth and slippery to further obstruct the non flying animal.

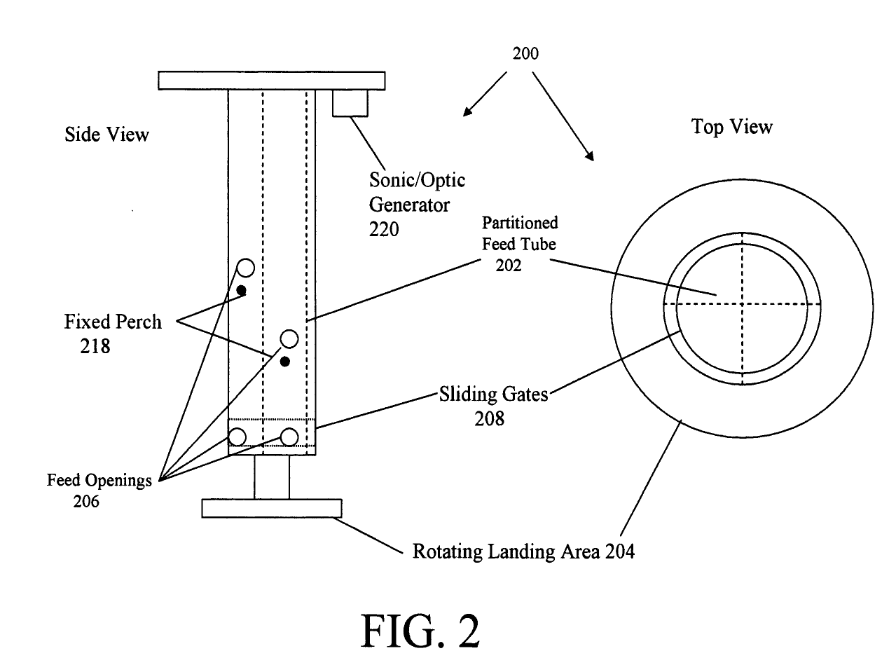

FIG. 2 illustrates a feeder device 200 according to various alternative embodiments of the invention, from both a side view and a top view. The numbers of the elements are similar to those given in FIG. 1, and nonessential portions have been removed for simplicity of understanding. The illustrated embodiment includes the feed tube 202 being internally partitioned to allow for different types of feed to be dispensed, each from its own group of feed openings 206, each opening potentially having a different size to favor a selected type of bird along with the selected type of feed. The illustrated embodiment also includes several non rotating, fixed landing areas or perches 218, illustratively shown as being at a higher level than the rotating landing area 204.

The rotating landing area is shown has having a number of feed openings 206, and a number of sliding gates 208 to close the feed openings 206 when the switch is actuated. The multiple gates may be formed as a number of spaced openings in a circular sleeve located either inside or outside the feed tube 202. The sleeve may be operated by a relay and returned to the non activated position by a spring. The illustrated embodiment includes a sonic and/or optic generator 220, which may produce loud noises and bright flashes of light in response to activation of one of the landing area, or perch, switches, which may be located in the rotating landing are 204 or the fixed perch 218, or both. In such a fashion the desired bird types may be allowed to easily obtain food, while discouraging undesired large birds or mammals from feeding at the feeder.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and structural, logical, and electrical changes may be made without departing from the scope of the disclosed embodiments. The various embodiments are not necessarily mutually exclusive, as some embodiments can be combined with one or more other embodiments to form new embodiments.

The terms “bird feeder” and “perch” as used in the description may include any structure for providing food to flying animals and having a landing area for the flying animals to utilize while accessing the feeder.

The term “horizontal” as used in this application is defined as a plane parallel to the conventional plane of the surface of the earth wafer, or to a plane perpendicular to a symmetry axis of the feeder, regardless of the orientation of the feeder. The term “vertical” refers to a direction perpendicular to the horizontal as defined above. Prepositions, such as “on”, “side”, “higher”, “lower”, “over” and “under” are defined with respect to the conventional plane or surface, regardless of actual static or momentary dynamic orientation of the feeder.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The detailed description is, therefore, not to be taken in a limiting sense, and the scope of the present invention is defined only by the appended claims, along with the full scope of equivalents to which such claims are entitled.

What is claimed is:

1. A feeder station, comprising:
a support structure connected to a food container;
a plurality of openings providing access to an interior portion of the food container;
a circular perch located outside the food container and adjacent to at least one opening, and capable of rotating relative to a rotational axis of the food container and the openings;
a switch connected to the perch, the switch responsive to at least one of a weight on the perch, a slope of the rotational axis away from vertical, and movement of the perch;
at least one movable gate located adjacent to the at least one opening, and disposed to close the opening in response to activation of the switch; and
a motor connected to the circular perch to rotate the perch in response to activation of the switch.

2. The feeder station of claim 2, wherein the perch rotates at least 60 revolutions per minute, the food container has at least four separate internal partitions, each one of the internal partitions communicates with different ones of the plurality of openings, and each individual opening having a selected size to control the type of animal that can access the food container.

3. The feeder station of claim 1, further including the movable gate located inside the bird food container, and the gate position controlled by a relay in response to activation of the switch.

4. A birdfeeder, comprising:
a support structure connected to a bird food container;
at least one opening disposed to provide access to the interior of the bird food container;
a landing area disposed adjacent to the at least one opening;
a switch connected to the perch; and
a gate disposed adjacent the at least one opening responsive to the activation of the switch to seal the at least one opening.

5. The birdfeeder of claim 4, further including a motor disposed to rotate the landing area with respect to the at least one opening in response to activation of the switch.

6. The birdfeeder of claim 5, further including the landing area rotates at least 60 revolutions per minute.

7. The birdfeeder of claim 4, further including the support structure rotationally connected to at least one of a top and a bottom of the bird food container.

8. The birdfeeder of claim 4, further including the opening having a selected size to determine the size of an animal that can access the interior of the bird food container.

9. The birdfeeder of claim 8, wherein the number of openings is four.

10. The birdfeeder of claim 9, wherein each of the four openings has a different size, and the bird food container is divided into four separate internal compartments.

11. The birdfeeder of claim 4, wherein the bird food container is substantially cylindrical in shape, has a long axis large enough to prevent a squirrel from hanging from an upper portion of the cylinder from reaching the at least one opening, and having a surface smoothness sufficient to prevent a squirrel from maintaining a hold on the food container.

12. The birdfeeder of claim 4, further including the gate located inside the bird food container.

13. The birdfeeder of claim 4, further including the gate operated by the same motor that rotates the landing area.

14. The birdfeeder of claim 4, further including the gate operated by a relay or solenoid in response to activation of the switch.

15. The birdfeeder of claim 4, further including the switch is adjustable to select a weight on the landing area that activates the switch.

16. The birdfeeder of claim 4, further including the switch is sensitive to a selected angle from vertical of a rotational axis of the bird food container.

17. The birdfeeder of claim 4, further including at least one of a loud noise generator, an electroshock generator, a vibration generator, an oscillatory motion of the perch generator, and a strobe light generator operationally connected to at least one of the switch connected to the perch, a motion sensor, a remote control, and a switch connected to the support structure.

18. A method of providing food for selected animals, comprising:
selecting a weight for activation of a switch;
selecting a velocity of rotation for a standing area;
closing a food access door in response to activation of the switch; and
rotating the standing area away from the food access door in response to activation of the switch.

19. The method of claim 18, further including selecting a size of the food access door.
